(19) United States
(12) Patent Application Publication
(10) Pub. No.: US 2025/0078225 A1
(43) Pub. Date: Mar. 6, 2025

(54) IMAGE PROCESSING DEVICE

(71) Applicant: CANON KABUSHIKI KAISHA, Tokyo (JP)

(72) Inventor: Yasushi ITO, Kanagawa (JP)

(21) Appl. No.: 18/800,188

(22) Filed: Aug. 12, 2024

(30) Foreign Application Priority Data
Sep. 1, 2023 (JP) 2023-142160

(51) Int. Cl. G06T 5/80; G06T 7/00

(52) U.S. Cl. CPC G06T 5/80; G06T 7/0002

(57) ABSTRACT

An image processing apparatus according to the present invention, includes a processor, and a memory storing a program which, when executed by the processor, causes the image processing apparatus to perform acquisition processing to acquire a frequency of each pixel value from an input image, perform correction processing to correct the frequency acquired in the acquisition processing, based on distortion of the input image, and perform generation processing to generate an assist image which indicates the frequency of each pixel value, based on the frequency of the correction processing.

### BACKGROUND OF THE INVENTION

### Field of the Invention

The present invention relates to an image processing apparatus, and more particularly to image processing for assist display.

### Description of the Related Art

A technique called cross reality (xR) is known. xR is a technique to integrate a real world and a virtual world, and includes virtual reality (VR), augmented reality (AR), and mixed reality (MR).

To capture an image for xR, a distortion-based wide angle lens, such as a fisheye lens, is frequently used to implement a high sense of immersion. If a square object is imaged using a fisheye lens, an image of a square object deformed in a barrel shape (fisheye image) is acquired. To display the captured image on such a display device as VR goggles, image processing to reduce distortion of the image (distortion correction processing), such as perspective projection transformation processing, is performed. Japanese Patent Application Publication No. 2008-61260 discloses a technique to reduce distortion of a fisheye image. Japanese Patent Application Publication No. 2008-61260 also discloses a technique to detect a person in a fisheye image.

In some cases, assist display, such as waveform monitor (WFM) display or peaking display, may be performed during imaging. In the WFM display, a waveform monitor image (WFM image), which indicates a distribution of brightness values and frequency thereof, is displayed. By performing the WFM display, the presence of white clipping or black clipping can be confirmed. In the peaking display, high frequency components of the image are emphasized. By performing the peaking display, focus can be confirmed, which can implement desired focus adjustment more easily. In a case of capturing a plurality of images (a plurality of image regions) using a plurality of lenses respectively, difference of focusing among the plurality of images can be confirmed by peaking display.

However features of an image (distorted image) before the distortion correction processing are different from features of the image after the distortion correction processing. In other words, if assist display is performed during displaying the image after the distortion correction processing, using the image before the distortion processing (not using the image after the distortion correction processing), features different from the currently displayed image (image after the distortion correction processing) are displayed by this assist display. As a result, the user may not easily recognize the real features of the currently display image, or may mistakenly recognize the features. If the image after the distortion correction processing is used, assist display, indicating the real features of this image, can be performed, but the distortion correction processing takes time and load, hence delay is generated to display the object image in live view.

### SUMMARY OF THE INVENTION

The present invention provides a technique that can perform assist display that indicates features equivalent to the features of the image after distortion correction processing, using the image before the distortion correction processing (not using the image after the distortion correction processing).

An image processing apparatus according to the present invention, includes a processor, and a memory storing a program which, when executed by the processor, causes the image processing apparatus to perform acquisition processing to acquire a frequency of each pixel value from an input image, perform correction processing to correct the frequency acquired in the acquisition processing, based on distortion of the input image, and perform generation processing to generate an assist image which indicates the frequency of each pixel value, based on the frequency of the correction processing.

Further features of the present invention will become apparent from the following description of exemplary embodiments with reference to the attached drawings.

### BRIEF DESCRIPTION OF THE DRAWINGS

FIG. 1 is a block diagram indicating a configuration example of an imaging apparatus;

FIG. 2 is a schematic diagram indicating an example of a plurality of divided regions;

FIG. 3A is a schematic diagram indicating an example of a perspective projection image;

FIG. 3B is a schematic diagram indicating an example of an assist image;

FIG. 3C is a schematic diagram indicating an example of a fisheye image;

FIG. 3D is a schematic diagram indicating an example of an assist image;

FIG. 4A is a schematic diagram indicating an example of an object region;

FIG. 4B is a schematic diagram indicating an example of a fisheye image region;

FIG. 5 is a schematic diagram for describing a method for determining a parameter n;

FIG. 6A is a schematic diagram indicating an example of a perspective projection image;

FIG. 6B is a schematic diagram indicating an example of an assist image;

FIG. 6C is a schematic diagram indicating an example of a fisheye image;

FIG. 6D is a schematic diagram indicating an example of an assist image;

FIG. 7A is a schematic diagram indicating an example of a perspective projection image;

FIG. 7B is a schematic diagram indicating an example of an assist image;

FIG. 7C is a schematic diagram indicating an example of a fisheye image;

FIGS. 7D and 7E are schematic diagrams indicating an example of assist display;

FIGS. 8A and 8B are schematic diagrams indicating an example of transition of brightness value of a fisheye image; and

FIG. 9 is a block diagram indicating a configuration example of an assist generation unit.

### DESCRIPTION OF THE EMBODIMENTS

### Embodiment 1

Embodiment 1 of the present invention will now be described. Here an example of an imaging apparatus having an assist display function will be described, but the image processing for assist display may be performed by an image processing apparatus (e.g. tablet terminal, personal computer, server) that is different from the image processing apparatus.

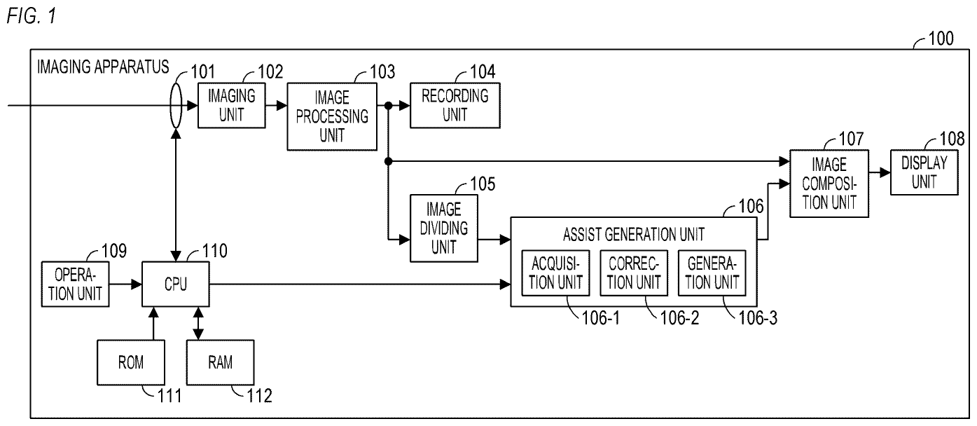

FIG. 1 is a block diagram indicating a configuration example of an imaging apparatus 100 according to Embodiment 1. The imaging apparatus 100 includes a lens unit 101, an imaging unit 102, an image processing unit 103, a recording unit 104, an image dividing unit 105, an assist generation unit 106, an image composition unit 107, a display unit 108, an operation unit 109, a CPU 110, a ROM 111 and a RAM 112.

The lens unit 101 includes an optical system which forms an object image on an imaging plane of the imaging unit 102. The lens unit 101 also has a zoom function, a focus adjustment function, and an aperture adjustment function. A lens that is used for the lens unit 101 is not especially limited, and a fisheye lens is used in Embodiment 1. The lens unit 101 may or may not be removable from the imaging apparatus 100.

The imaging unit 102 images an object. For example, the imaging unit 102 includes a plurality of photoelectric conversion elements, and converts an object image (optical image) formed by the lens unit 101 into image signals. The imaging unit 102 may be a complementary metal oxide semiconductor (CMOS) image sensor, or a charged coupled device (CCD) image sensor.

The image processing unit 103 performs various kinds of image processing on an image signal outputted from the imaging unit 102. For example, the image processing unit 103 performs A/D conversion processing to convert an image signal (analog signal) into an image data (digital signal), or performs scratch correction processing to reduce scratches caused by the imaging unit 102. In Embodiment 1, it is assumed that the image data is YCbCr data, in which each pixel value is a YCbCr value. The YCbCr value indicates a Y value (brightness value), a Cb value (color difference value), and a Cr value (color difference value).

The image processing unit 103 can also perform distortion reduction processing to reduce distortion of a fisheye image (distorted image captured by a fisheye lens). The distortion reduction processing used here is not especially limited, and the perspective projection transformation processing is used in Embodiment 1. An image generated after the perspective projection transformation processing is called a “perspective projection image”. The image processing unit 103 can output the fisheye image (image data of the fisheye image), or output the perspective projection image (image data of the perspective projection image). The fisheye image can be outputted before the perspective projection transformation processing, but the perspective projection image can be outputted only after the perspective projection transformation processing. In Embodiment 1, it is assumed that the image processing unit 103 outputs the fisheye image to the image dividing unit 105 in order to reduce delay of processing.

The recording unit 104 records the image data from the image processing unit 103 in a storage medium (recording medium), such as an SD card. The images to be recorded in the storage medium may be fisheye images or perspective projection images, or both fisheye images and perspective projection images.

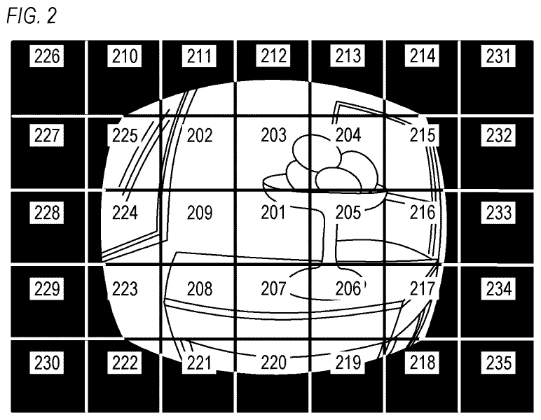

The image dividing unit 105 divides a fisheye image (input image) outputted from the image processing unit 103 into a plurality of divided regions (a plurality of divided images) which are arranged in a grid pattern. A number of divided regions and arrangement thereof are not especially limited, and, for example, the image dividing unit 105 divides the fisheye image into 35 divided regions 201 to 235 arranged in a 7 row by 5 column matrix, as indicated in FIG. 2.

The assist generation unit 106 generates an assist image that indicates a frequency (a number of times) of each pixel value using a fisheye image (without using a perspective projection image). In Embodiment 1, it is assumed that the assist generation unit 106 generates a waveform monitor image (WFM image), which indicates distribution and frequency of the brightness value of the image, as the assist image.

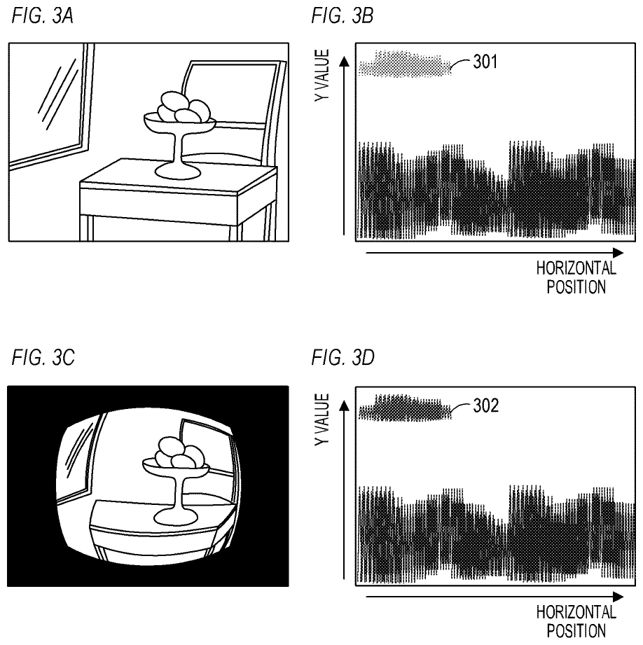

FIG. 3A is a schematic diagram indicating an example of the perspective projection image, and FIG. 3B is a schematic diagram indicating an example of the WFM image which is generated using the perspective projection image in FIG. 3A. The abscissa of the WFM image in FIG. 3B indicates a horizontal position (a position in the horizontal direction) of the perspective projection image in FIG. 3A, and the ordinate of the WFM image in FIG. 3B indicates the brightness value (Y value). In the WFM image in FIG. 3B, frequency of each brightness value in the perspective projection image (horizontal position) in FIG. 3A is indicated by lightness (light and shade). For example, a region 301 in the WFM image in FIG. 3B corresponds to a window region of the perspective projection image in FIG. 3A, where frequency of the brightness value is high, hence the region 301 is indicated bright.

FIG. 3C is a schematic diagram indicating an example of a fisheye image based on which the perspective projection image in FIG. 3A is generated, and FIG. 3D is a schematic diagram indicating an example of a WFM image which is generated using the fisheye image in FIG. 3C. In FIG. 3D, an invalid region (black region outside a valid region indicating an object) is not considered. The fisheye image is an image of which distortion of the image increases as the distance from the center increases, and of which edges are more compressed than the center portion. Therefore the WFM image in FIG. 3D, which indicates the frequency of each brightness value in the fisheye image, becomes different from the WFM image in FIG. 3B which indicates the frequency of each brightness value in the perspective projection image. For example, compared with an edge of the perspective projection image, a number of pixels is less in an edge of the fisheye image, hence the region 302 in the WFM image in FIG. 3D (region corresponding to the window region in the fisheye image in FIG. 3C), is indicated darker (less frequency) than the region 301 in FIG. 3B.

Therefore in Embodiment 1, the frequency of each pixel value is corrected based on the distortion (degree of distortion, distortion ratio) of the fisheye image, and the assist image (WFM image) is generated based on the corrected frequency. Thereby using the image before the distortion correction processing (not using the image after the distortion correction processing), assist display (display of the WFM image), indicating features equivalent to the features of the image after the distortion correction processing, can be performed.

The assist generation unit 106 includes an acquisition unit 106-1, a correction unit 106-2, and a generation unit 106-3. The acquisition unit 106-1 acquires a frequency (frequency information) of each pixel value (each brightness value) from the fisheye image (input image). The correction unit 106-2 corrects the frequency acquired by the acquisition unit 106-1 based on the distortion of the fisheye image. In Embodiment 1, it is assumed that the acquisition unit 106-1 and the correction unit 106-2 perform the processing for each of the plurality of divided regions acquired by the image dividing unit 105 respectively. For example, for each of the plurality of divided regions, the acquisition unit 106-1 acquires the frequency of each pixel value from the image in this divided region. Further, for each of the plurality of divided regions, the correction unit 106-2 corrects the frequency of each pixel value in this divided region based on the distortion of the image in this divided region. The generation unit 106-3 generates a WFM image based on the frequency after correction by the correction unit 106-2.

The image composition unit 107 generates a composite image by composing (superimposing) the assist image outputted from the assist generation unit 106 on the perspective projection image outputted from the imaging unit 102.

The display unit 108 displays the composite image outputted from the image composition unit 107. The display unit 108 is an electronic view finder (EVF) or a rear face monitor, for example. The image to be displayed may be switchable between the perspective projection image and the assist image.

The operation unit 109 receives various operations which the user performs with the imaging apparatus 100. For example, the user performs various operations, including operation to change the ISO sensitivity, operation to change the shutter speed, operation to switch between enable/disable of the assist display, and operation to change the type of the assist display.

The CPU 110 is a control unit to control the imaging apparatus 100 in general. The ROM 111 is a non-transitory non-volatile memory which stores various data (information), such as image data, audio data, and various programs for the CPU 110 to operate. The RAM 112 is a volatile memory which temporarily stores various data. For example, the CPU 110 controls each component of the imaging apparatus 100 in accordance with the programs stored in the ROM 111 using the RAM 112 as a work memory.

When an operation signal, in accordance with the operation by the user (user operation), is received from the operation unit 109, the CPU 110 controls each component of the imaging apparatus 100 in accordance with this operation signal. The CPU 110 also acquires information on a lens used for capturing the fisheye image (input image). For example, the CPU 110 acquires information on the type of the lens, which was acquired from the lens unit 101. Then the CPU 110 determines distortion of the fisheye image based on the acquired information, and controls processing of the assist generation unit 106 (correction unit 106-2). In the case where the lens used for imaging is fixed, the information on the distortion of the fisheye image can be determined in advance, hence the CPU 110 may acquire the information on the distortion of the fisheye image without acquiring the information on the lens. The CPU 110 may also control the processing of the assist generation unit 106 (correction unit 106-2) based on the acquired information (information on distortion of the fisheye image).

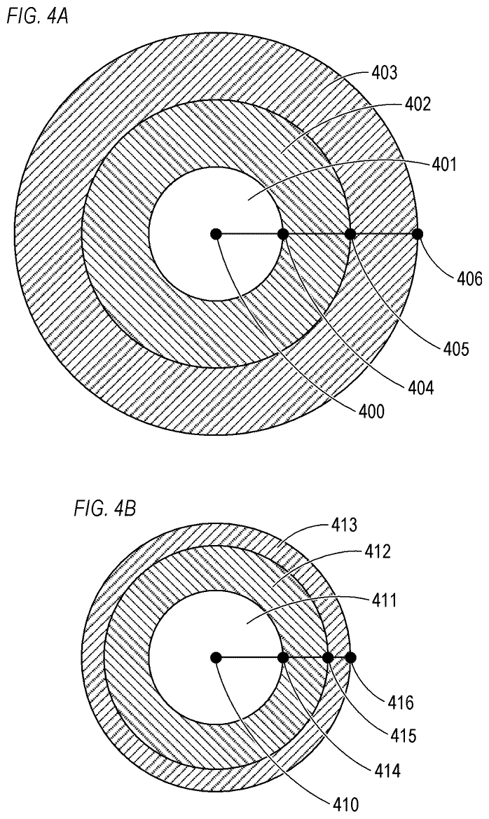

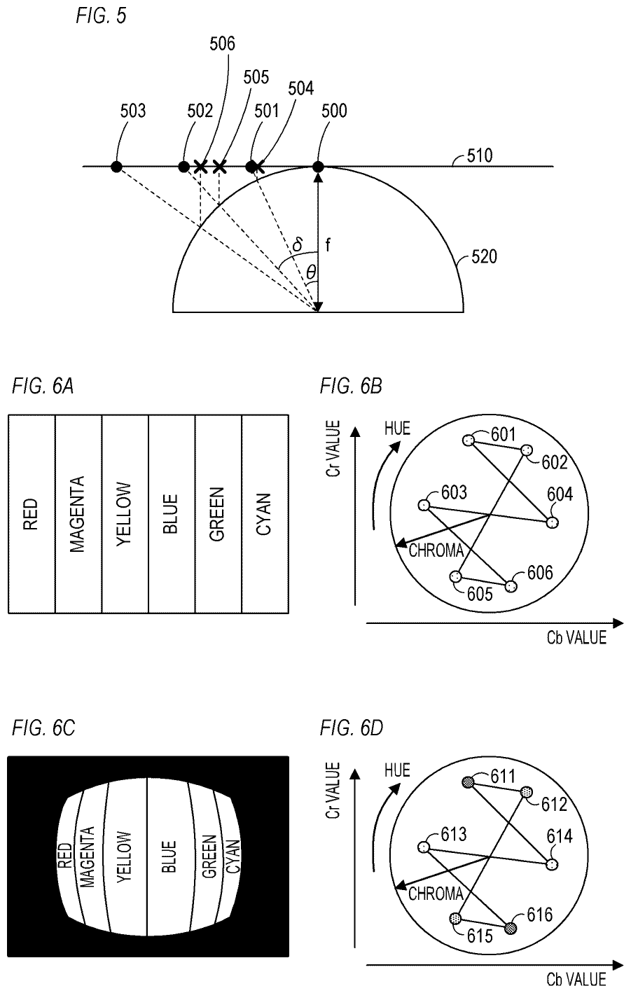

An operation example according to Embodiment 1 will be described with reference to FIGS. 4A, 4B and 5.

FIG. 4A is a schematic diagram indicating an example of a region of an object (object region). Each of regions 401 to 403 is a region centered around a point 400, and a radius of the region 401, a distance from the outer edge of the region 401 to the outer edge of the region 402, and a distance from the outer edge of the region 402 to the outer edge of the region 403 are the same. A point 404 is a point on the outer edge of the region 401, a point 405 is a point on the outer edge of the region 402, and a point 406 is a point on the outer edge of the region 403.

FIG. 4B is a schematic diagram indicating an example of a region of a fisheye image (fisheye image region) capturing the object region in FIG. 4A. Each of regions 411 to 413 is a region centered around a point 410, and a point 410 corresponds to the point 400 in FIG. 4A, and the regions 411 to 413 correspond to the regions 401 to 403 in FIG. 4A respectively. Because of distortion of the image, the distance from the outer edge of the region 411 to the outer edge of the region 412 is shorter than the radius of the region 411, and the distance from the outer edge of the region 412 to the outer edge of the region 413 is shorter than the distance from the outer edge of the region 411 to the outer edge of the region 412. A point 414 is a point on the outer edge of the region 411, a point 415 is a point on the outer edge of the region 412, and a point 416 is a point on the outer edge of the region 413.

FIG. 5 is a schematic diagram for describing a method for determining a parameter n (magnification) to correct the frequency of each pixel value (each brightness value). A point 500 on a plane 510 corresponds to the point 400 in FIG. 4A and the point 410 in FIG. 4B. Points 501 to 503 on the plane 510 correspond to the points 404 to 406 in FIG. 4A respectively, and points 504 to 506 on the plane 510 correspond to the points 414 to 416 in FIG. 4B respectively. FIG. 5 is an example of using a fisheye lens 520.

For example, the CPU 110 acquires information on the lens used for capturing the fisheye image, and determines a radius f based on this information. Then using the following Expression 1, the CPU 110 calculates an angle θ between the optical axis of the fisheye lens 520 and an imaging direction of the point 501 (direction passing through the center of curvature of the fisheye lens 520 and the point 501), from the radius f of the fisheye lens 520 and a distance a from the point 500 to the point 501.

$$θ = {tan}^{- 1} ( a / f ) \qquad ( Expression 1 )$$

Then using the following Expression 2, the CPU 110 calculates a distance b from the point 500 to the point 504.

$$b = f \times sin θ = f \times sin ( {tan}^{- 1} ( a / f ) ) \qquad ( Expression 2 )$$

Then using the following Expression 3, the CPU 110 calculates an angle δ between the optical axis of the fisheye lens 520 and an imaging direction of the point 502 (direction passing through the center of curvature of the fisheye lens 520 and the point 502), from the radius f of the fisheye lens 520 and a distance 2a from the point 500 to the point 502.

$$δ = {tan}^{- 1} ( 2 a / f ) \qquad ( Expression 3 )$$

Then using the following Expression 4, the CPU 110 calculates a distance c from the point 500 to the point 505.

$$c = f \times sin δ = f \times sin ( {tan}^{- 1} ( 2 a / f ) ) \qquad ( Expression 4 )$$

Then using the following Expression 5, the CPU 110 calculates a distance d from the point 504 to the point 505.

$$d = c - b = f \times sin ( {tan}^{- 1} ( 2 a / f ) ) - f \times sin ( {tan}^{- 1} ( a / f ) ) \qquad ( Expression 5 )$$

Then using the following Expression 6, the CPU 110 calculates a parameter n which indicates the distortion of the image in the region 412 in FIG. 4B. The distortion of the image is larger as the parameter n is greater.

$$n = b / d = ( f \times sin ( {tan}^{- 1} ( a / f ) ) ) / ( f \times sin ( {tan}^{- 1} ( 2 a / f ) ) - f \times sin ( {tan}^{- 1} ( a / f ) ) ) \qquad ( Expression 6 )$$

In the same manner, the CPU 110 calculates a distance e from the point 505 to the point 506, and calculates a parameter n=b/e which indicates the distortion of the image in the region 413 in FIG. 4B. For the parameter n that indicates the distortion of the image in the region 411 in FIG. 4B, the CPU 110 determines a parameter n=1. For the parameter n that corresponds to the invalid region of the fisheye image, the CPU 110 determines a parameter n=0. The invalid region can be determined from the information on the lens used for capturing the fisheye image.

A number of the plurality of regions to calculate the parameter n is not especially limited, and may be more or less than 4. The plurality of regions to calculate the parameter n and the plurality of divided regions acquired by the image dividing unit 105 may be the same or different. Here an example of calculating the ratio of the distances for the parameter n was described, but a ratio of surface areas may be calculated for the parameter n.

Then the CPU 110 sets the determined plurality of parameters n in the assist generation unit 106 (correction unit 106-2). For each of the plurality of divided regions, the correction unit 106-2 multiplies the frequency of each pixel value in this divided region by a representative value (e.g. maximum value, minimum value or mean value) of the parameters n corresponding to this divided region. Thereby the frequency of each pixel value in a region of which distortion of the image is determined to be large (e.g. a region of which parameter n is larger than a threshold) increases. In the case of FIG. 2, the frequency in the divided region 201 (region corresponding to parameter n=1) is not corrected, and the frequency in the divided regions 202 to 217 (regions corresponding to parameter n that is larger than 0 and smaller then 1) is increased based on the value of the parameter n. The frequency of the divided regions 226 to 235 (regions corresponding to parameter n=0) is corrected to 0. By using frequency corrected like this, a WFM image equivalent to the WFM image in FIG. 3B is acquired from the fisheye image in FIG. 3C. In a region of which distortion of the image is determined to be small (e.g. a region of which parameter n is smaller than a threshold), the frequency of each pixel value may be decreased. Only one of the processing to increase the frequency and the processing to decrease the frequency may be performed, or both processing may be performed.

As described above, according to Embodiment 1, the frequency of each pixel value is corrected based on the distortion (degree of distortion, distortion ratio) of the fisheye image, and the assist image (WFM image) is generated based on the corrected frequency. Thereby using the image before the distortion correction processing (not using the image after the distortion correction processing), assist display (display of the WFM image), indicating features equivalent to the features of the image after the distortion correction processing, can be performed.

Here a case where the input image is the fisheye image was described, but the input image may be a distorted image other than the fisheye image. For example, the input image may be an image captured by a lens that is different from the fisheye lens, or an equidistant cylindrical type image, or an equidistant projection type image. Further, a case where the plurality of regions arranged in a grid pattern was described here, but the plurality of divided regions may be a different kind of plurality of divided regions. For example, the plurality of divided regions may be a plurality of regions arranged concentrically. Further, a case where the assist image is the WFM image was described here, but the assist image may be a different image that indicates a frequency of each pixel value. For example, the assist image may be a histogram image that indicates a histogram of gradation values (pixel values), such as brightness values.

### Embodiment 2

Embodiment 2 of the present invention will now be described. In Embodiment 1, the WFM image is generate as the assist image. In Embodiment 2, a vector scope image, which indicates distribution and frequency of a combination of hue and chroma, is generated as the assist image. In the following, description on the same aspects as Embodiment 1 (e.g. the same configuration and processing as Embodiment 1) will be omitted, and aspects different from Embodiment 1 will be described.

FIG. 6A is a schematic diagram indicating an example of a perspective projection image, and FIG. 6B is a schematic diagram indicating an example of a vector scope image generated using the perspective projection image in FIG. 6A. The abscissa of the vector scope image in FIG. 6B indicates a Cb value, and the ordinate of the vector scope image in FIG. 6B indicates a Cr value. The direction (axis) along the outer periphery of the vector scope image (circular image) indicates hue. In the vector scope image, if a position changes around the center of the vector scope image in the direction along the outer periphery of the vector scope image, hue changes corresponding to the position. The distance from the center of the vector scope image indicates chroma, and the chroma is higher as the distance is longer. In the vector scope image in FIG. 6B, the frequency of each pixel value (each combination of the Cb value and the Cr value, each combination of hue and chroma) in the perspective projection image in FIG. 6A is indicated by lightness (density). In FIG. 6B, a plot 601 corresponds to red, a plot 602 corresponds to magenta, a plot 603 corresponds to yellow, a plot 604 corresponds to blue, a plot 605 corresponds to green, and a plot 606 corresponds to cyan. In the perspective projection image in FIG. 6A, a size of a region of red, a size of a region of magenta, a size of a region of yellow, a size of a region of blue, a size of a region of green, and a size of a region of cyan are the same. Therefore in the vector scope image in FIG. 6B, the plots 601 to 606 are indicated by the same lightness.

FIG. 6C is a schematic diagram indicating an example of a fisheye image based on which the perspective projection image in FIG. 6A is generated, and FIG. 6D is a schematic diagram indicating an example of a vector scope image which is generated using the fisheye image in FIG. 6C. In FIG. 6D, an invalid region is not considered. In FIG. 6D, a plot 611 corresponds to red, a plot 612 corresponds to magenta, a plot 613 corresponds to yellow, a plot 614 corresponds to blue, a plot 615 corresponds to green, and a plot 616 corresponds to cyan. The fisheye image is an image of which distortion of the image increases as the distance from the center increases, and of which edges are more compressed than the center position. Therefore the vector scope image in FIG. 6D, which indicates the frequency of each pixel value in the fisheye image, becomes different from the vector scope image in FIG. 6B, which indicates the frequency of each pixel value in the perspective projection image. For example, the plots 601 to 606 are indicated by the same lightness in the vector scope image in FIG. 6B, but lightness of the plots 611 to 616 disperse in the vector scope image in FIG. 6D.

Therefore in Embodiment 2, the frequency of each pixel value is corrected based on the distortion (degree of distortion, distortion ratio) of the fisheye image, and the assist image (vector scope image) is generated based on the corrected frequency. Thereby using the image before the distortion correction processing (not using the image after the distortion correction processing), assist display (display of the vector scope image), indicating features equivalent to the features of the image after the distortion correction processing, can be performed.

An operation example according to Embodiment 2 will be described. Using the same method as Embodiment 1, the CPU 110 determines a plurality of parameters n which correspond to a plurality of regions of the fisheye image respectively, and sets the plurality of parameters n in the assist generation unit 106 (correction unit 106-2). Using the same method as Embodiment 1, the correction unit 106-2 corrects the frequency of each pixel value. By using the frequency corrected like this, a vector scope image equivalent to the vector scope image in FIG. 6B can be acquired from the fisheye image in FIG. 6C.

As described above, according to Embodiment 2, the frequency of each pixel value is corrected based on the distortion (degree of distortion, distortion ratio) of the fisheye image, and the assist image (vector scope image) is generated based on the corrected frequency. Thereby using the image before the distortion correction processing (not using the image after the distortion correction processing), assist display (display of the vector scope image), indicating features equivalent to the features of the image after the distortion correction processing, can be performed.

Here a case where the assist image is the vector scope image was described, but the assist image may be a different image that indicates the frequency of each pixel value. For example, the assist image may be a chromaticity diagram image (e.g. xy chromaticity diagram image that indicates the xy chromaticity diagram), which indicates the distribution of the chromaticity and the frequency.

### Embodiment 3

Embodiment 3 of the present invention will now be described. In Embodiment 1 (and Embodiment 2), the assist image is displayed as the assist display. In Embodiment 3, a peaking display, which emphasizes high frequency components of the image, is performed as the assist display. In the peaking display, a contour of a focused object is emphasized by a color. In the peaking display, colors added to high frequency components may be differentiated among a plurality of partial regions constituting a range of a spatial frequency corresponding to the high frequency components. In the peaking display, a high frequency component may be emphasized at a higher degree of emphasis as the spatial frequency thereof is higher. In the following, description on the same aspects as Embodiment 1 (e.g. the same configuration and processing as Embodiment 1) will be omitted, and aspects different from Embodiment 1 will be described.

The assist generation unit 106 detects high frequency components which are higher than a threshold, from the fisheye image (e.g. pixel value (brightness value) of each pixel), and generates a high frequency component image indicating the detected high frequency components. The high frequency component image may be interpreted as an assist image. For example, the assist generation unit 106 detects high frequency components using a high-pass filter (HPF). The detection condition of the high frequency components (threshold to define high frequency components) may be changeable in according with the user operation. For example, a filter coefficient of the HPF may be changeable in according with the user operation. If the filter coefficient of the HPF changes, the cutoff frequency (threshold to define high frequency components) of the HPF also changes. The method for emphasizing the high frequency components in the peaking display may be changeable in accordance with the user operation. For example, the color added to the high frequency components may be changeable in accordance with the user operation.

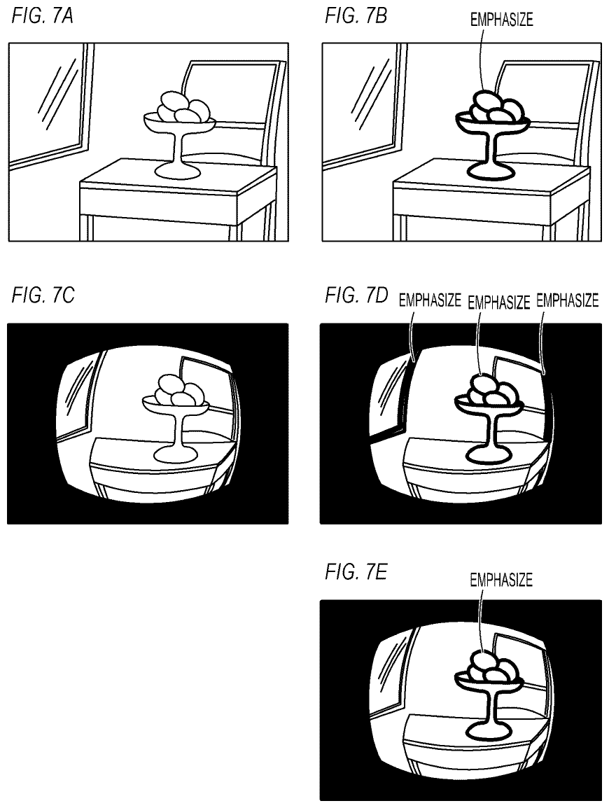

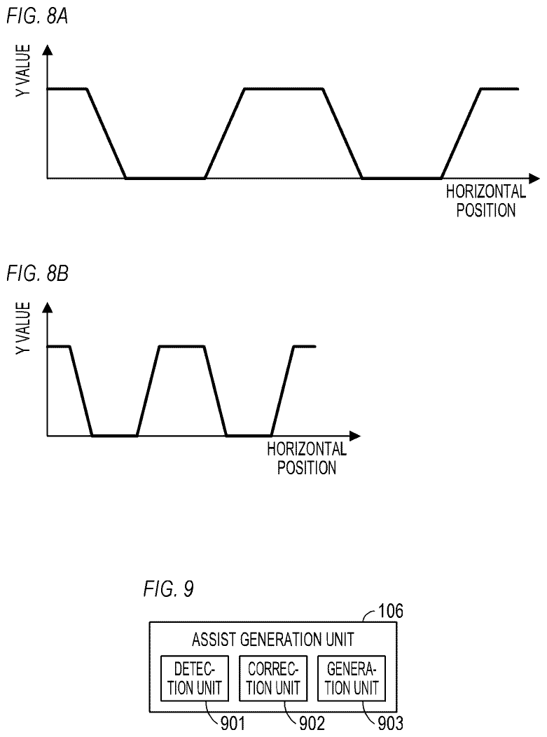

FIG. 7A is a schematic diagram indicating an example of a perspective projection image, and FIG. 7B is a schematic diagram indicating an example of a peaking display using the perspective projection image in FIG. 7A. FIG. 7C is a schematic diagram indicating an example of a fisheye image based on which the perspective projection image in FIG. 7A is generated, and FIG. 7D is a schematic diagram indicating an example of the peaking display which is generated using the fisheye image in FIG. 7C. FIGS. 8A and 8B are schematic diagrams indicating examples of the transition of brightness values of the fisheye image in the horizontal direction. The abscissa of FIGS. 8A and 8B indicates a horizontal position, and the ordinate of FIGS. 8A and 8B indicates a brightness value (Y value). FIG. 8A indicates a transition at the center portion of the fisheye image, and FIG. 8B indicates a transition at the edge of the fisheye image. The transition in FIG. 8A and the transition in FIG. 8B are the same transition in the perspective projection image. However, the fisheye image is an image in which distortion of the image increases as the distance from the center increases, and of which edges are more compressed than the center portion. Therefore at the edges, as indicated in FIGS. 8A and 8B, the transition of the pixel values become sharper than the center portion, and high frequency components are more easily detected. As a result, an emphasized object (portion) becomes different between the peaking display in FIG. 7D using the fisheye image and the peaking display in FIG. 7B using the perspective projection image. For example, in the peaking display in FIG. 7D, the objects (window frame and part of a chair) are emphasized at the edges of the fisheye image, which are not emphasized in the peaking display in FIG. 7B.

Therefore in Embodiment 3, the detection condition of high frequency components (threshold to define high frequency components) is corrected based on the distortion (degree of distortion, distortion ratio) of the fisheye image, and the high frequency components are detected based on the corrected detection condition. Thereby using the image before the distortion correction processing (not using the image after the distortion correction processing), assist display (peaking display), indicating features equivalent to the features of the image after the distortion correction processing, can be performed.

FIG. 9 is a block diagram indicating a configuration example of the assist generation unit 106 according to Embodiment 3. The assist generation unit 106 according to Embodiment 3 includes a detection unit 901, a correction unit 902, and a generation unit 903. The detection unit 901 detects high frequency components, which are frequency components higher than a threshold, from the fisheye image (input image). For example, the detection unit 901 detects the high frequency components using an HPF. The correction unit 902 corrects the detection condition of high frequency components (threshold to define high frequency components) based on the distortion of the fisheye image. For example, the correction unit 902 corrects the filter coefficient of the HPF. In Embodiment 3, it is assumed that each of the detection unit 901 and the correction unit 902 performs the processing for each of the plurality of divided regions acquired by the image dividing unit 105. For example, the detection unit 901 detects the high frequency components from each of the plurality of divided regions. For each of the plurality of divided regions, the correction unit 902 corrects the detection condition in this divided region, based on the distortion of the image in this divided region. The generation unit 903 generates a high frequency component image that indicates the high frequency components detected by the detection unit 901.

In Embodiment 3, the image composition unit 107 composes (superimposes) a high frequency components image, outputted from the assist generation unit 106, on the fisheye image outputted from the imaging unit 102, so as to generate a composite image, which is a fisheye image of which high frequency components are emphasized. The image processing to emphasize the high frequency components is not limited to the composition of the high frequency component image. For example, the high frequency components of the fisheye image may be emphasized by performing the image processing to change pixel values on the fisheye image.

An operation example according to Embodiment 3 will be described. Using the same method as Embodiment 1, the CPU 110 determines a plurality of parameters n which correspond to a plurality of regions of the fisheye image respectively, and sets the plurality of parameters n in the assist generation unit 106 (correction unit 902). For each of the plurality of divided regions, the correction unit 902 corrects the detection condition of the high frequency components (threshold to define high frequency components) in this divided region, based on a representative value (e.g. maximum value, minimum value, or mean value) of the parameters n corresponding to this divided region. For example, the correction unit 902 increases the threshold in a region in which distortion of the image is determined to be large, so as to make detection condition in this area more strict, or decreases the threshold in a region in which distortion of the image is determined to be small, so as to relax the detection condition in this region. By using the detection condition corrected like this, the peaking display in FIG. 7E can be performed using the fisheye image in FIG. 7C. The object (portion) to be emphasized is the same in the peaking display in FIG. 7E using the fisheye image and the peaking display in FIG. 7B using the perspective projection image. Only one of the processing to increase the threshold and the processing to decrease the threshold may be performed, or both may be performed.

As described above, according to Embodiment 3, the detection condition of the high frequency components (threshold to define high frequency components) is corrected based on the distortion (degree of distortion, distortion ratio) of the fisheye image, and the high frequency components are detected based on the corrected detection condition. Thereby using the image before the distortion correction processing (not using the image after the distortion correction processing), assist display (peaking display), indicating features equivalent to the features of the image after the distortion correction processing, can be performed.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, assist display, indicating features equivalent to the features of the image after the distortion correction processing, can be performed using the image before the distortion correction processing (not using the image after the distortion correction processing).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-142160, filed on Sep. 1, 2023, which is hereby incorporated by reference herein in its entirety.

What is claimed is:

1. An image processing apparatus comprising:
a processor; and
a memory storing a program which, when executed by the processor, causes the image processing apparatus to
perform acquisition processing to acquire a frequency of each pixel value from an input image,
perform correction processing to correct the frequency acquired in the acquisition processing, based on distortion of the input image, and
perform generation processing to generate an assist image which indicates the frequency of each pixel value, based on the frequency of the correction processing.

2. The image processing apparatus according to claim 1, wherein
in the correction processing, the frequency of each pixel value is increased in a region of which the distortion is determined to be large.

3. The image processing apparatus according to claim 1, wherein
in the correction processing, the frequency of each pixel value is decreased in a region of which the distortion is determined to be small.

4. The image processing apparatus according to claim 1, wherein
the input image is an image captured using a fisheye lens, an equidistant cylindrical type image, or an equidistant projection type image.

5. The image processing apparatus according to claim 1, wherein
in the correction processing, for each of a plurality of regions of the input image, the frequency of each pixel value in the region is corrected, based on distortion of an image in the region.

6. The image processing apparatus according to claim 5, wherein
the plurality of regions are a plurality of regions arranged in a grid pattern or a plurality of regions arranged concentrically.

7. The image processing apparatus according to claim 1, wherein
the program, when executed by the processor, further causes the image processing apparatus to perform second acquisition processing to acquire information on a lens used for capturing the input image, wherein
in the correction processing, the frequency acquired in the acquisition processing is corrected based on distortion of the input image determined based on the information.

8. The image processing apparatus according to claim 1, wherein
in the generation processing, the assist image is generated regarding the frequency of each pixel value in an invalid region of the input image as 0.

9. The image processing apparatus according to claim 1, wherein
the assist image is a waveform monitor image which indicates distribution and frequency of a brightness value, a histogram image which indicates distribution and frequency of a brightness value, a vector scope image which indicates distribution and frequency of a combination of hue and chroma, or a chromaticity diagram image which indicates distribution and frequency of chromaticity.

10. An image processing apparatus comprising:
a processor; and
a memory storing a program which, when executed by the processor, causes the image processing apparatus to
perform detection processing to detect, from an input image, frequency components higher than a threshold,
perform correction processing to correct the threshold based on distortion of the input image, and
perform image processing, to emphasize the high frequency components detected in the detection processing, on the input image.

11. The image processing apparatus according to claim 10, wherein
in the correction processing, the threshold is increased in a region of which the distortion is determined to be large.

12. The image processing apparatus according to claim 10, wherein
in the correction processing, the threshold is decreased in a region of which the distortion is determined to be small.

13. The image processing apparatus according to claim 10, wherein
the input image is an image captured using a fisheye lens, an equidistant cylindrical type image, or an equidistant projection type image.

14. The image processing apparatus according to claim 10, wherein
in the correction processing, for each of a plurality of regions of the input image, the threshold in the region is corrected based on distortion of an image in the region.

15. The image processing apparatus according to claim 14, wherein
the plurality of regions are a plurality of regions arranged in a grid pattern, or a plurality of regions arranged concentrically.

16. The image processing apparatus according to claim 10, wherein
the program, when executed by the processor, further causes the image processing apparatus to perform acquisition processing to acquire information on a lens used for capturing the input image, wherein
in the correction processing, the threshold is corrected based on distortion of the input image determined based on the information.

17. An image processing method comprising:
acquiring a frequency of each pixel value from an input image;
correcting the acquired frequency based on distortion of the input image; and
generating an assist image which indicates the frequency of each pixel value, based on the corrected frequency.
